(19) United States
(12) Patent Application Publication
(10) Pub. No.: US 2025/0177248 A1
(43) Pub. Date: Jun. 5, 2025

(54) Medication Dispenser Apparatus

(71) Applicant: IAGE TECH LIMITED, Dublin 16 (IE)

(72) Inventors: Christine KING, Dublin 16 (IE); Aoife LAWLER, Naas, Co. Kildare (IE)

(21) Appl. No.: 18/845,839

(22) PCT Filed: Mar. 7, 2023
(86) PCT No.: PCT/EP2023/055705

§ 371 Date: Sep. 10, 2024

(30) Foreign Application Priority Data
Mar. 10, 2022 (EP) 22161284.9

(51) Int. Cl. A61J 1/03

(52) U.S. Cl. CPC A61J 1/035

(57) ABSTRACT

The present invention relates to a medication dispenser apparatus comprising a removable medication container having a plurality of pockets, each pocket configured for releasably containing medication to be dispensed, a holding means for the medication container, a dispensing outlet for dispensed medication, pushing means operable to push medication from a pocket of the medication container for delivery to the dispensing outlet, and positioning means to align the pushing means with a pocket of the medication container containing medication to be dispensed, in which the pushing means is actuated to apply a sufficient pressing or punching force to the pocket to push the medication out of the medication container to the dispensing outlet. The apparatus is configured to dispense medication from a medication container to a user/patient according to a specified medical regimen or prescription. The holding means is configured so that the medication container may be manually removed from the apparatus by a user/patient and replaced with relative ease. The apparatus is configured as a tabletop or desktop appliance, is portable and of relative lightweight to enable user/patients to carry and position it in any desired location.

The present invention relates to a medication dispenser apparatus.

Medication dispensers are operable to dispense medications in a manner that assists patients in taking and complying with prescribed medication requirements. Such dispensers are configured to dispense medications at a predetermined time and in the correct dosage according to the patient's prescription.

However, known medication dispensers suffer from drawbacks, including that they are often configured to dispense medications in individual sachets separated from a pre-loaded strip pack of sachets, whereby the dispensed individual sachets are difficult for patients to manually manipulate in order to open to obtain access the medications once dispensed. Furthermore, such strip pack type medication dispensers are often complicated and difficult for users to reload.

Other known medication dispensers use pharmacy supplied medication container packaging in the form of a blister pack, which is a packaging device having a substantially flat card like base member with pockets or pouches containing medication to be dispensed extending in a spaced apart array arrangement on the base member. However, such dispensers are also limited in that they are only able to dispense medications using blister packs that have a very specific predefined configuration in terms of size, dimension or other physical parameter. Accordingly, the dispenser will be rendered unusable should any relatively minor change be made to the size or dimensions of the blister pack packaging. It is further not possible for such known blister packs to be reused.

It is a therefore an object of the present invention to provide a medication dispenser apparatus that goes at least some way toward overcoming the above problems and/or which will provide the public and/or industry with a useful alternative.

Further aspects of the present invention will become apparent from the ensuing description which is given by way of example only.

According to the invention, there is provided a medication dispenser apparatus comprising:
a removable medication container having a plurality of pockets, each pocket configured for releasably containing medication to be dispensed,
a holding means for the medication container,
a dispensing outlet for dispensed medication,
pushing means operable to push medication from a pocket of the medication container for delivery to the dispensing outlet, and
positioning means to align the pushing means with a pocket of the medication container containing medication to be dispensed, in which the pushing means is actuated to apply a sufficient pressing or punching force to the pocket to push the medication out of the medication container to the dispensing outlet,
characterised in that the holding means comprises a pair of spaced apart parallel clamping arms, each clamping arm configured with clamping members to releasably grasp and thereby releasably hold the medication container in the apparatus such that the medication container is held by and extends between the clamping arms,
in which one of the clamping arms is fixed and the other of the clamping arms is moveable within the apparatus, in which the clamping arms are mounted between and spaced apart by a pair of support bars, and the least one moveable clamping arm is slidable along the supports to increase or decrease and separation distance between the clamping arms for holding the medication container,
in which each clamping arm comprises a fixed clamping member and a rotatable clamping member, in which the fixed clamp member is connected between the support bars and the rotatable clamping member is rotatably connected at one end to the fixed clamping member and comprises a free end, and
in which the rotatable clamping member is operable by its free end to be moved between a closed configuration in which clamping surfaces of the clamping members are engaged and grip the medication container therebetween, and an open configuration in which the clamping surfaces of the clamping members are not engaged and the medication container is removable from the apparatus.

This configuration provides an improved means for enabling medication containers of different size and dimension to be easily inserted into and removed from the apparatus by a user. The rotatable clamping member of each clamping arm is manually lifted and manually closed by a user/patient or carer to raise and lower the rotatable clamping member onto and off the fixed clamping member to facilitate removal and insertion of a medication container into the apparatus.

The medication container when held extends between the clamping arms and is retained between clamping surfaces of the clamping arms.

The holding means may in alternative embodiments be configured as a shelf provided by as a surface, in which the medication container may rest or sit on the shelf when loaded into the holding means.

Preferably, the positioning means comprises a gantry slidably coupled to a pair of spaced apart support guides.

In further embodiments, the means to position and move the pushing head to the desired pocket containing the medication to be dispensed may additionally or alternatively be provided with cogs, gears, pneumatics, and/or rack and pinion systems.

Preferably, the pushing means is slidable along the gantry.

Preferably, the gantry further comprises an integrally formed leverage arm configured to extend under the gantry and medication container when present in the apparatus.

Preferably, the pushing means comprises a pushing head operable when actuated to apply a sufficient pressing or pushing force to deform a pocket of the medication container to push medication contained in a pocket out through a pocket opening.

Preferably, actuation of the pushing means is in a substantially vertically downward action to push medication contained in a pocket out of the medication container.

The slidable gantry and slidable pushing means together ensure that the pushing head may be positioned such that medication in all pockets of the medication container may be dispensed.

In further embodiments, the pushing means may be configured with other means suitable for forcing or engagement to push or urge pills out of the chamber or pocket of the medication container. For example, the pushing means may be provided by or include cogs, gears, pneumatics or a rack and pinion systems operable to cause the pills to be dispensed from a pocket of the medication container.

Preferably, a user interface operable to receive input from a user encoding or defining a medication regimen, and the software processor control means is operable to control the positioning means and the pushing means and operation of the apparatus to automatically dispense medication according to the regimen.

Preferably, the user interface means is further operable to provide visual and//or audio signals to a user when it is time to take medication, when medication has been dispensed and when the medication container is empty and needs to be replaced and/or refilled.

Preferably, the medication container comprises a substantially flat card like base member and the pockets containing medication to be dispensed extend in a spaced apart array arrangement on the base member, and each pocket of the medication container comprises an arrangement of slits or flaps in the base member thereof to provide a close-able opening for refilling the pocket.

Preferably, the medication container is made from a bendable material, such as silicone. The provision of a refillable bendable medication container allows it bend for loading and unloading medication into the pockets. The pockets may be preloaded by a user/patient or carer.

Preferably, the apparatus comprises a housing, and the dispenser outlet is provided as an opening in the housing.

Preferably, the holding means for inserting and removing a medication container is accessible by a closable door or lid in the housing.

Preferably, the medication dispenser apparatus further comprises software processor control means to control the operation of the positioning means and the pushing means to automatically dispense medication from the medication container.

A cup is provided to receive dispensed medication from the dispenser outlet.

The present invention provides a medication dispenser apparatus that is configured to dispense medication from a medication container to a user/patient according to specified medical regimen or prescription. The medication container, which is of the type known in the dispensing industry as a “blister pack” has pockets or pouches that contain medication in the form of pills to be dispensed in a prescribed dosage.

The present invention provides a holding means to ensure that the medication container is securely and releasably held in the medication dispenser apparatus. The holding means is configured so that the medication container may be manually removed from the apparatus by a user/patient and replaced with relative ease. The holding means is configured for use with medication containers and blister packs provided by most well-known pharmacies.

The present invention provides a pushing means operable to push medication from a pocket of the medication container for delivery to a dispensing outlet. A positioning means aligns the pushing means with the pocket of the medication container containing medication to be dispensed and is actuated to push the pills held in the pocket out of the medication container. The medication pushed and thereby released from the medication container is then directed or channelled to a dispensing outlet on a directing surface of the apparatus.

The invention further provides a refillable medication container in which pockets are configured with slits or serrations formed in a base member thereof so that when the pockets of the medication container are empty or dispensed, they may be refilled by the user/patient or carer.

A large user interface display is operable to guide users/patients with visual and/or audio indications regarding when to take medications, which are manually or automatically dispensed according to settings that are programmed into software control means of the apparatus. The user interface display also alerts users/patients when the medication container needs to be replaced, such as when all pockets containing medications are empty.

The apparatus is configured as a tabletop or desktop type appliance, is portable and of relative lightweight to enable user/patients to carry and position it in any desired location, and may be used in both hospital, care home and residential settings as required or desired.

The invention will be more clearly understood from the following description of some embodiments thereof, given by way of example only, with reference to the accompanying drawings.

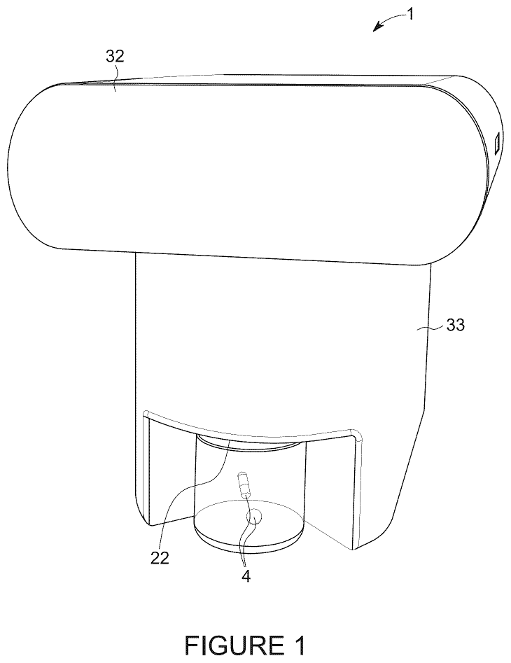

FIG. 1 is a front view of a medication dispenser apparatus configured according to the present invention,

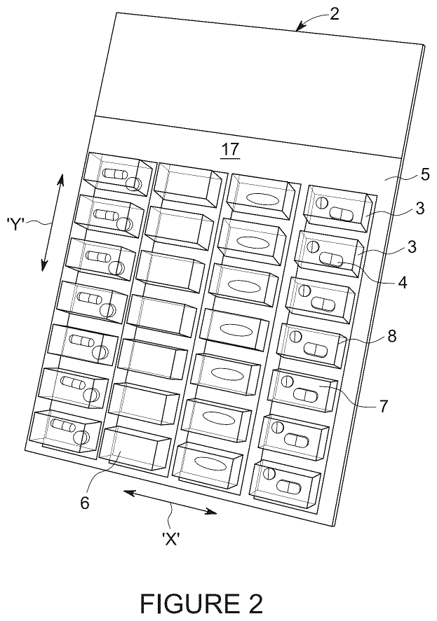

FIG. 2 is a perspective view of a medication container for use with the medication dispenser apparatus,

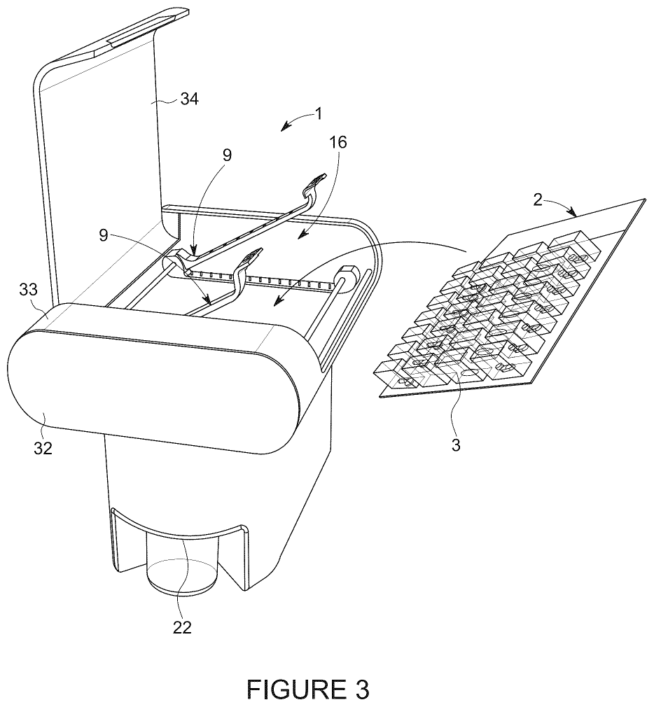

FIG. 3 is a top perspective view of the medication dispenser apparatus showing insertion of the medication container of FIG. 2,

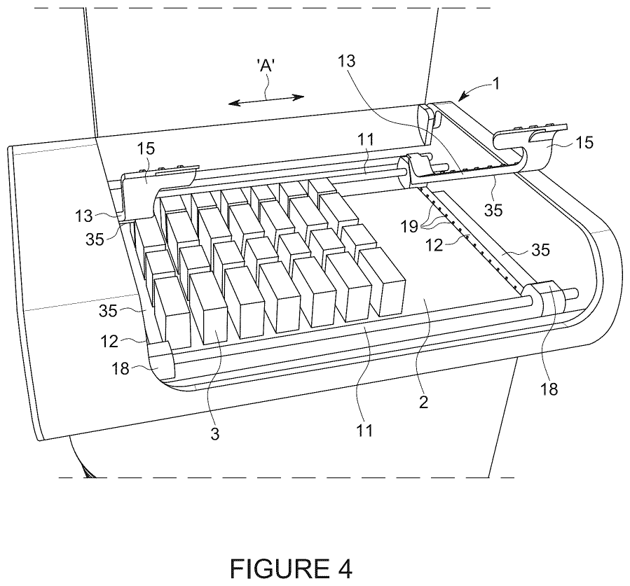

FIG. 4 is a top perspective view of the medication dispenser apparatus with a parts cutaway to show the medication container being releasably secured therein,

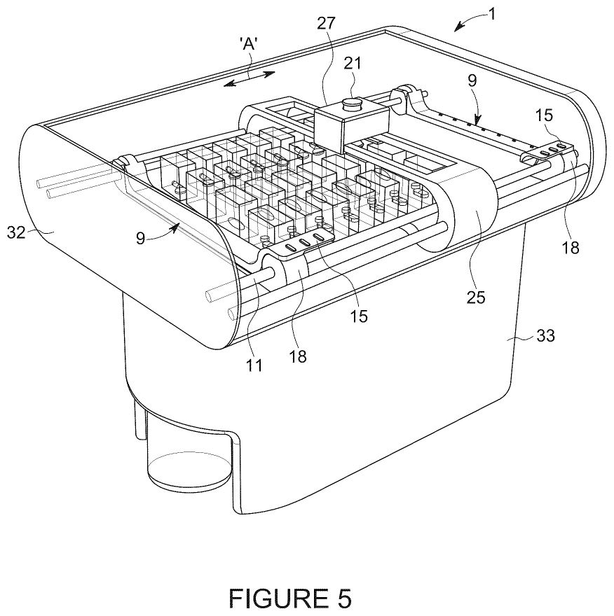

FIG. 5 is a top perspective view of the medication dispenser apparatus with a parts cutaway to show the medication container releasably secured therein,

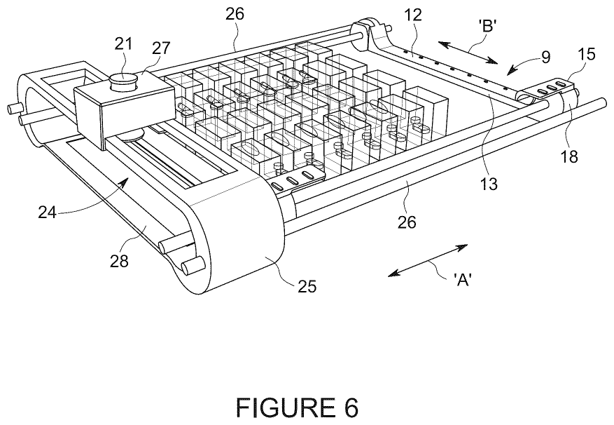

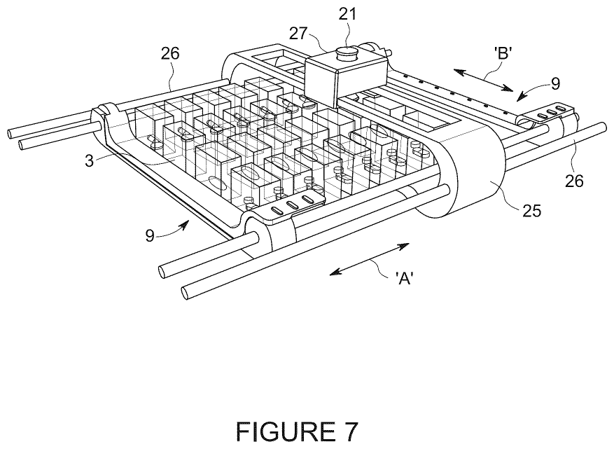

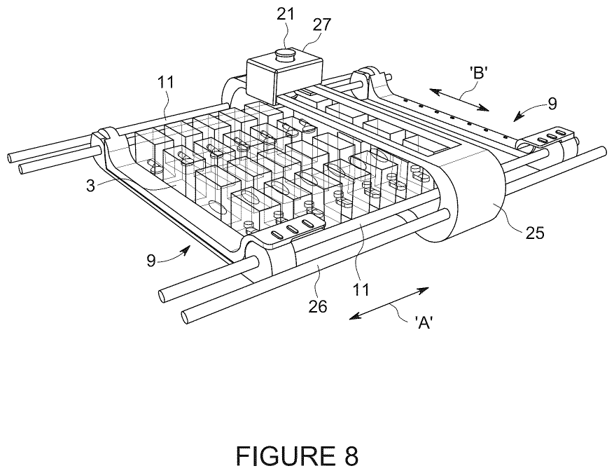

FIGS. 6 to 8 are top perspective views showing the operation of the positioning means of the medication dispenser apparatus, and

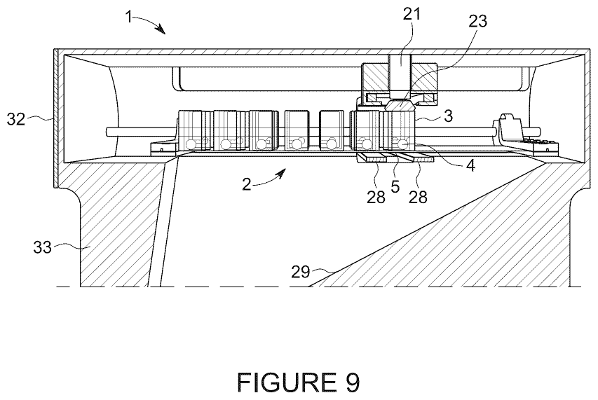

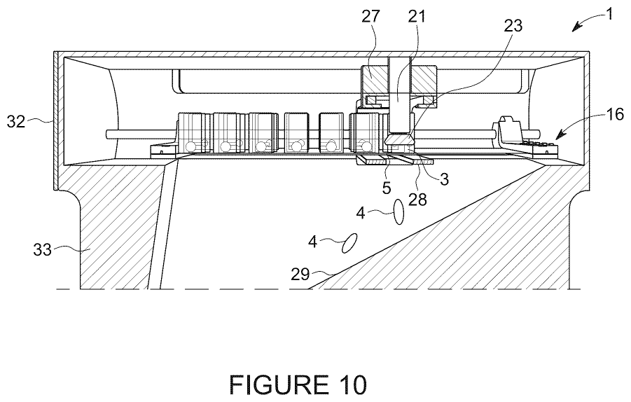

FIGS. 9 and 10 are sectional views showing the operation of the pushing means of the medication dispenser apparatus.

Referring to the drawings, there is shown a medication dispenser apparatus 1 comprising a removable medication container 2 having a plurality of pockets 3, each pocket 3 configured for releasably containing medication 4 to be dispensed by the medication dispenser apparatus 1.

The medication container 2 is of the type known in the industry as a “blister pack” or “blister pouch” and is configured from a substantially flat card like base member 5 with pockets or pouches 3 containing medication 4 to be dispensed extending upwardly from the base member 5 in a spaced apart array arrangement on the base member 5. Each pocket 3 is formed from an upstanding wall 8 which extends from the base member 5 to define an enclosure for medication 4 to be dispensed.

Each pocket 3 holds medication to be dispensed as a dose at a given time of day and on a particular day in a medicinal regimen. For example, the pockets or pouches 3 may be arranged in a weekly configuration, in which the required medication for each day of the week, and at specific times of the day are provided.

In the example shown in FIG. 2, twenty-eight pockets 3 are shown and these correspond to dosages to be dispensed by the apparatus 1 for up to seven days of the week (corresponding to the ‘Y’ axis extending from the top to the bottom on the upward facing surface 17 of the medication container 2) and four times each day (corresponding to the ‘X’ axis extending from the left side to the right side on the upward facing surface 17 of the medication container 2).

It will however be understood that the above configuration is given by way of example only and that the medication container 2 for use with the apparatus 1 may be configured with any number of pockets 3 and in a dispensing arrangement or configuration according to the patient's medicinal regimen requirements. The four by seven array of pockets 3 shown in FIG. 2 is thus by way of example only and should not be seen as limiting. Other configurations for the medication container are therefore envisaged according to the invention.

Each pocket 3 of the medication container 2 further optionally comprises an arrangement of slits or flaps 6 that extend through the portion of the base member 5 forming a base side wall 7 of a pocket 3. The slits or flaps 6 provide a close-able opening for refilling the pocket 3 with medication. The medication container 2 may be made from silicone or other suitable material to enable the medication container to be flexible and bendable for ease of filling with pills and removal and insertion into the apparatus 1.

In alternative embodiments, the base member 5 and side wall 8 may be made from a suitable plastic that is designed to be pushed through so medications within a pocket 3 are released via an opening formed in the base side wall 7 of the base member 5 as the medication pills within the pocket 3 are pushed through, thereby not requiring the base member 5 to have slits or flaps 6 formed therein for releasing medications contained in a pocket 3.

As shown in FIGS. 3 and 4, the medication dispenser apparatus 1 includes a holding means, indicated generally by the reference numeral 16, for securely and releasably holding a medication container 2 in the apparatus. 1. The holding means 16 comprises a pair of spaced apart parallel clamping arms, each indicated generally by the reference numeral 9, in which each clamping arm 9 is configured with a fixed clamping member 12 and a rotatable clamping member 13 to releasably grasp and thereby releasably hold the medication container 2 in the apparatus 1. The clamping members 12, 13 each comprise clamping surfaces 35 between which edges of the medication container 2 are firmly grasped and held. The medication container 2 is held by and thus extends between the clamping arms 9.

Each fixed clamping member 12 is connected between support bars 11 and each rotatable clamping member 13 is rotatably connected at one end to the fixed clamp member 12 and comprises a free end 15.

The rotatable clamping member 13 is operable by its free end 15 to be moved between a closed configuration in which clamping surfaces 35 of the clamping arms 9 are engaged and grip edges of the medication container 2 therebetween, and an open configuration in which the clamping members 12, 13 are open such that the clamping surfaces 35 are not engaged and the medication container 2 is able to be removed from the apparatus 1.

At least one of the clamping arms 9 is moveable within the apparatus 1. In the instance shown one of the clamping arms 9 is fixed and the other of the clamping arms 9 is moveable back and forth along the support bars 11 within the apparatus 1 in the direction shown by feature arrow ‘A’ in FIG. 4. Such a configuration enables the distance between the clamping arms 9 to be increased and decreased to thereby accommodate and hold medication containers 2 of different sizes.

Accordingly, if a medication container 2 is of a smaller size the moveable clamping arm 9 may be manually or automatically moved closer toward the fixed clamping arm 9 to decrease the distance therebetween, and if a larger medication container 2 is to be inserted then the moveable clamping arm 9 is moved further away from the fixed clamping arm 9 to increase the distance between the clamping arms 9 for holding the medication container.

Sliding movement of the or each of the clamping arms 9 along the supports 11 may be manually performed by a user/patient or automatically by software control means based on input received at a user interface by the user/patient, such input may for example, be enabled by the user/patient selecting a specific type of medication container 2 useable with the apparatus 1 such that the apparatus 1 is configured on receiving a signal encoding the type of medication container 2 to automatically move the or each clamping arm 9 a required distance to accommodate the selected type of medication container 2.

As shown, edges of the base member 5 of the medication container 2 are grasped between clamping surfaces 35 of the fixed clamping member 12 and the rotatable clamping member 13 to hold the medication container 2 in the apparatus 1. The base member 5 of the medication container 2 is seated in the apparatus 1 on the mounting surfaces 35 of the fixed clamping members 12.

Jaws or teeth 19 are provided along the clamping surfaces 35 of the fixed clamping member 12 to grasp the base member 5 of the medication container 2 when seated thereon.

The free end 15 of the rotatable clamping member 13 is configured to releasably connect with the end 18 of the fixed clamping member 12 to releasably connect the clamping member 12, 13 together to firmly grip and hold edges of the medication container 2.

Also shown in FIG. 5 is a pushing means 21 operable to push medication from a pocket 3 of the medication container 2 for delivery to the dispensing outlet 22.

As shown in FIGS. 9 and 10, the pushing means 21 has a pushing head 23 that is operable when actuated to apply a sufficient pressing or pushing force to deform a pocket 3 of the medication container 2 to thereby push medication 4 contained in the pocket 3 through the base member 5 of the medication container 2 to the dispensing outlet 22. The pushing head 23 thus acts much like a piston moving up and down to dispense medications 4 from each pocket 3 of the medication container 2 at the required day and time to dispense medications 4 according to a medicinal regimen. As shown, the holding means 16 is operable to releasably retain the medication container 2 below the pushing means 21 and the pushing head 23 pushes down upon the upstanding side wall 8 of each pocket 3 to push medications out through the slits/flaps 6 or the base wall 7 depending on the configuration of the medication container 2.

As shown in FIGS. 6 to 8, a positioning means, indicated generally by the reference numeral 24, is provided to align and position the pushing means 21 with a pocket 3 of the medication container 2 containing medication 4 to be dispensed.

The positioning means 24 comprises a gantry 25 slidably coupled to a pair of support guides 26, in which the pushing means 21 is mounted in a seat 27 slidable along the gantry 25. The gantry 25 further comprises an integrally formed leverage arm 28 configured to extend under the gantry 25 and medication container 2 when present in the apparatus 1. The leverage arm 28 provides a leveraging surface for the pushing head 23 against the medication container 2 as medication is being pushed out of a pocket 3.

The slidable connection of both the gantry 25 to the support guides 26 and the pushing means 21 to the gantry 25 enable the pushing head 23 of the pushing means 21 to be aligned with each pocket 3 of the medication container 2.

As shown in FIGS. 6 to 8, to position the pushing means 21 as required above a desired pocket, the gantry 25 moves back and forth, in the direction indicated generally by the reference arrow ‘A’, along the support guides 26 and the seat 27 slides back and forth in the direction indicated generally by the reference arrow ‘B’, along the gantry 25. Such a configuration for the positioning means 24 ensures that medications 4 in all pockets 3 of the medication container 2 are reached by the pushing means 21 to be dispensed.

Medications 4 pushed from a pocket 3 of the medication container 2 are directed by surfaces 29 within the apparatus 1 to slide down to the dispensing outlet 30 for dispensed medication. A cup 31 and light may optionally be provided at the dispensing outlet 30.

The medication dispenser apparatus 1 further comprises software processor control means to control the operation of the positioning means 24 and the pushing means 21 to automatically dispense medication 4 from the medication container 2.

The medication dispenser apparatus 1 further comprises a user interface means 32 provided as a touch screen/display 32 and/or optionally via a user application (or app) that is operable to receive input from a user/patient encoding or defining a medication regimen, and the software processor control means is operable to control the positioning means 24 and the pushing means 21 and operation of the apparatus 1 to automatically dispense medication 4 according to the regimen. The apparatus 1 may also be programmed to dispense medications 4 on demand, that is, when prompted by a user/patient to dispense.

The user interface means is further operable to provide visual and//or audio signals to a user when it is time to take medication, when medication has been dispensed and when the medication container is empty and needs to be replaced and/or refilled. The user interface display 32 displays medication prompt and dispensing information, time and other useful information for patients.

The apparatus 1 is provided in a housing 33, and the dispenser outlet 30 is provided as an opening in the housing 33. The holding means 16 for inserting and removing a medication container is accessible by a closable door or lid 34 in the housing 33.

It is to be understood that the invention is not limited to the specific details described herein which are given by way of example only and that various modifications and alterations are possible without departing from the scope of the invention.

1. A medication dispenser apparatus comprising:
a removable medication container having a plurality of pockets, each of the plurality of pockets is configured for releasably containing medication to be dispensed,
a holding means for the medication container,
a dispensing outlet for dispensed medication, pushing means operable to push medication from a pocket of the medication container for delivery to the dispensing outlet, and
positioning means to align the pushing means with a pocket of the medication container containing medication to be dispensed, in which the pushing means is actuated to apply a sufficient pressing or punching force to the pocket to push the medication out of the medication container to the dispensing outlet, characterised in that the holding means comprises a pair of spaced apart parallel clamping arms, each clamping arm configured with clamping members to releasably grasp and thereby releasably hold the medication container in the apparatus such that the medication container is held by and extends between the clamping arms,
in which one of the clamping arms is fixed and the other of the clamping arms is moveable within the apparatus,
in which the clamping arms are mounted between and spaced apart by a pair of support bars, and the least one moveable clamping arm is slidable along the supports to increase or decrease and separation distance between the clamping arms for holding the medication container,
in which each clamping arm comprises a fixed clamping member and a rotatable clamping member, in which the fixed clamp member is connected between the support bars and the rotatable clamping member is rotatably connected at one end to the fixed clamping member and comprises a free end, and
in which the rotatable clamping member is operable by its free end to be moved between a closed configuration in which clamping surfaces of the clamping members are engaged and grip the medication container therebetween, and an open configuration in which the clamping surfaces of the clamping members are not engaged and the medication container is removable from the apparatus.

2. The medication dispenser apparatus as claimed in claim 1, in which the positioning means comprises a gantry slidably coupled to a pair of spaced apart support guides.

3. The medication dispenser apparatus as claimed in claim 2, in which the pushing means is slidable along the gantry.

4. The medication dispenser apparatus as claimed in claim 1, in which the pushing means comprises a pushing head operable when actuated to apply a sufficient pressing or pushing force to deform a pocket of the medication container to push medication contained in a pocket out through a pocket opening.

5. The medication dispenser apparatus as claimed in claim 1, in which the pushing means is in activated with a substantially vertically downward action to push medication contained in a pocket out of the medication container.

6. The medication dispenser apparatus as claimed in claim 1, further comprising a user interface operable to receive input from a user encoding for defining a medication regimen, and a software processor control means that is operable to control the positioning means and the pushing means and operation of the apparatus to automatically dispense medication according to the medication regimen.

7. The medication dispenser apparatus as claimed in claim 1, in which the user interface is further operable to provide visual and/or audio signals to a user when it is time to take medication, when medication has been dispensed and when the medication container is empty and needs to be replaced and/or refilled.

8. The medication dispenser apparatus as claimed in claim 1, in which the medication container comprises a substantially flat card like base member and the pockets containing medication to be dispensed extend in a spaced apart array arrangement on the base member, and each pocket of the medication container comprises an arrangement of slits or flaps in the base member thereof to provide a close-able opening for refilling the pocket.

9. The medication dispenser apparatus as claimed in claim 1, in which the medication container is made from a bendable material, such as silicone.

10. The medication dispenser apparatus as claimed in claim 1, in which the apparatus comprises a housing, and the dispenser outlet is provided as an opening in the housing.

11. The medication dispenser apparatus as claimed in claim 10, in which the holding means for the medication container is accessible by a closable door or lid in the housing.
